(19) United States
(12) Patent Application Publication
(10) Pub. No.: US 2021/0072704 A1
(43) Pub. Date: Mar. 11, 2021

(54) Timepiece Component And Timepiece

(71) Applicant: Seiko Epson Corporation, Tokyo (JP)

(72) Inventor: Shogo KOBAYASHI, Shiojiri (JP)

(21) Appl. No.: 17/012,140

(22) Filed: Sep. 4, 2020

(30) Foreign Application Priority Data
Sep. 6, 2019 (JP) 2019-162774

(51) Int. Cl. G04B 37/22; G04B 37/00

(52) U.S. Cl. CPC G04B 37/22; C22C 38/00; G04B 37/0008

(57) ABSTRACT

A timepiece component is formed of an austenitic-ferritic stainless steel including a base portion formed of a ferrite phase, a surface layer formed of an austenitic phase, and a mixed layer formed between the base portion and the surface layer and obtained by mixing the ferrite phase and the austenitic phase. A recessed portion is formed in the surface layer and a distance from a front surface of the surface layer to a bottom surface of the recessed portion is shorter than a distance from the front surface to the mixed layer.

The present application is based on, and claims priority from JP Application Serial Number 2019-162774, filed Sep. 6, 2019, the disclosure of which is hereby incorporated by reference herein in its entirety.

### BACKGROUND

### 1. Technical Field

The present disclosure relates to a timepiece component and a timepiece.

### 2. Related Art

In JP-A-2009-69049, there is disclosed a housing for a timepiece, specifically, a case body and a case back, that uses a ferritic stainless steel in which a surface layer is austenitized by a nitrogen absorption treatment.

In JP-A-2009-69049, with the surface layer of the ferritic stainless steel being austenitized, a hardness and a corrosion resistance required as a housing for a timepiece are achieved.

In the housing for a timepiece described in JP-A-2009-69049, a marking may be applied to a portion of the housing by, for example, laser machining or the like in order to impart an identification description or a representation of the design. At this time, when a portion of the marking location passes through the austenitic phase and reaches the ferrite phase, the ferrite phase is exposed through the marking location. When this happens, there is a problem in that the corrosion resistance required as a housing for a timepiece may not be achieved.

### SUMMARY

A timepiece component according to the present disclosure is formed of an austenitic-ferritic stainless steel including a base portion formed of a ferrite phase, a surface layer formed of an austenitic phase, and a mixed layer formed between the base portion and the surface layer and obtained by mixing the ferrite phase and the austenitic phase. A recessed portion is formed in the surface layer and a distance from a front surface of the surface layer to a bottom surface of the recessed portion is shorter than a distance from the front surface to the mixed layer.

In the timepiece component according to the present disclosure, the distance from the front surface to the bottom surface may be greater than or equal to 1.5 μm and less than 350 μm.

In the timepiece component according to the present disclosure, the distance from the front surface to the bottom surface may be from 5 μm to 20 μm.

In the timepiece component according to the present disclosure, an arithmetical mean roughness Ra of the bottom surface may be different from an arithmetical mean roughness Ra of the front surface.

In the timepiece component according to the present disclosure, the recessed portion may constitute at least one of a letter, a number, a sign, an engraving, a mark, a code, an emblem, and a symbol.

A timepiece according to the present disclosure includes the timepiece component.

### BRIEF DESCRIPTION OF THE DRAWINGS

FIG. 1 is a front view illustrating a timepiece of an exemplary embodiment.

FIG. 2 is a drawing illustrating an example of a case back of the timepiece.

FIG. 3 is a drawing illustrating main parts of the case back.

FIG. 4 is a photograph showing a cross section of the case back on which laser machining was performed.

### DESCRIPTION OF EXEMPLARY EMBODIMENTS

### Embodiments

Below, an exemplary embodiment according to the present disclosure will be described with reference to the drawings.

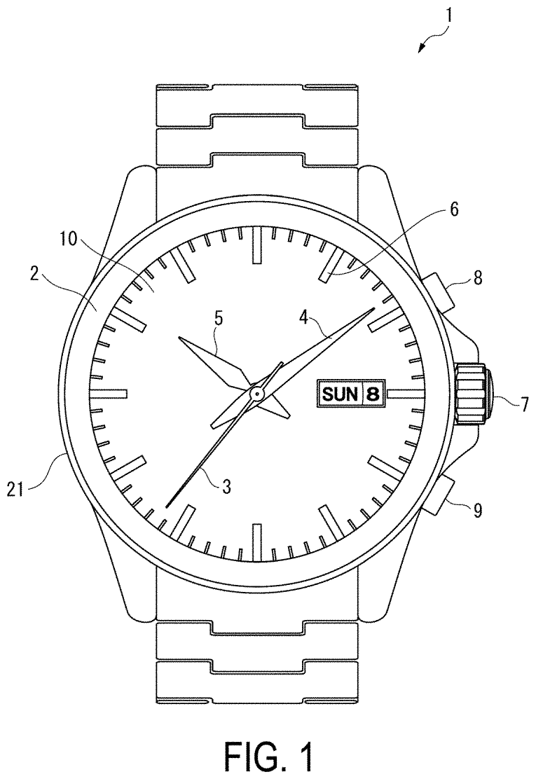

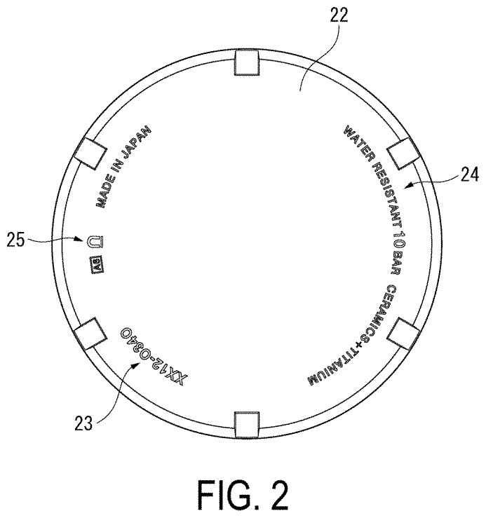

FIG. 1 is a front view illustrating a timepiece 1, and FIG. 2 is a drawing illustrating a case back 22 of the timepiece 1. In this exemplary embodiment, the timepiece 1 is configured as a wristwatch worn on a wrist of a user.

As illustrated in FIGS. 1 and 2, the timepiece 1 includes a case 2 made of a metal. The case 2 includes a case main body 21 having a cylindrical shape and the case back 22 attached to an opening on a back side of the case main body 21. Then, an interior of the case main body 21 is provided with a dial 10, a second hand 3, a minute hand 4, an hour hand 5, a crown 7, an A button 8, and a B button 9. The dial 10 is provided with an hour mark 6 for indicating an hour. Note that the case back 22 is an example of a timepiece component of the present disclosure.

Case Back

As illustrated in FIG. 2, a model number 23, a water resistance performance indication 24 indicating a water resistance performance, and a magnetic resistance performance indication 25 indicating a magnetic resistance performance are formed on the case back 22. Note that the model number 23 and the water resistance performance indication 24 are examples of a letter and a number of the present disclosure, and the magnetic resistance performance indication 25 is an example of a sign of the present disclosure.

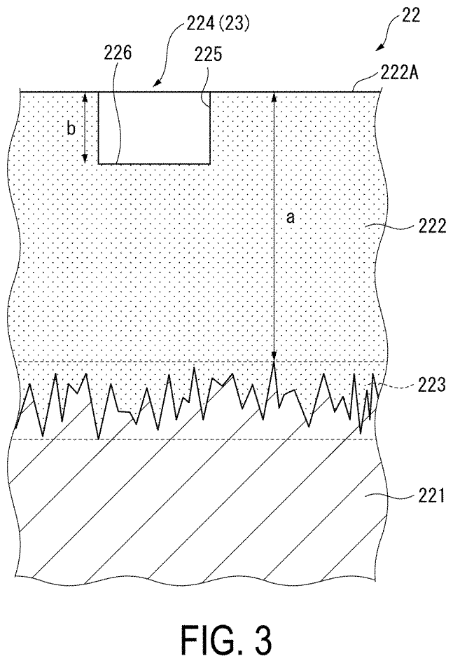

FIG. 3 is a cross-sectional view illustrating main parts of the case back 22. Note that FIG. 3 illustrates a cross-sectional view in which the case back 22 is cut from the front surface side in a depth direction, that is, the case back 22 is cut in a direction orthogonal to the front surface.

As illustrated in FIG. 3, the case back 22 is formed of an austenitic-ferritic stainless steel including a base portion 221 formed of a ferrite phase, a surface layer 222 formed of an austenitic phase, and a mixed layer 223 in which the ferrite phase and the austenitic phase are mixed. Then, a recessed portion 224 is formed in the surface layer 222.

Base Portion

The base portion 221 is formed of a ferritic stainless steel containing, in mass %, 18 to 22% of Cr, 1.3 to 2.8% of Mo, 0.05 to 0.50% of Nb, 0.1 to 0.8% of Cu, less than 0.5% of Ni, less than 0.8% of Mn, less than 0.5% of Si, less than 0.10% of P, less than 0.05% of S, less than 0.05% of N, and less than 0.05% of C, with the balance being Fe and unavoidable impurities.

Cr is an element that, in the nitrogen absorption treatment, enhances a transfer rate of nitrogen to the ferrite phase and a diffusion rate of nitrogen in the ferrite phase. When Cr is less than 18%, the transfer rate and the diffusion rate of nitrogen become low. Furthermore, when Cr is less than 18%, a corrosion resistance of the surface layer 222 decreases. On the other hand, when Cr exceeds 22%, the material hardens and a processability thereof is negatively affected. Furthermore, when Cr exceeds 22%, an aesthetic appearance is diminished. Therefore, the content of Cr is preferably 18 to 22%, more preferably set to 20 to 22%, and more preferably set to 19.5 to 20.5%.

Mo is an element that, in the nitrogen absorption treatment, enhances the transfer rate of nitrogen to the ferrite phase and the diffusion rate of nitrogen in the ferrite phase. When Mo is less than 1.3%, the transfer rate and the diffusion rate of nitrogen become low. Furthermore, when Mo is less than 1.3%, the corrosion resistance of the material is reduced. On the other hand, when Mo exceeds 2.8%, the material hardens and the processability thereof is negatively affected. Further, when Mo exceeds 2.8%, the composition of the surface layer 222 becomes significantly inhomogeneous, diminishing the aesthetic appearance. Therefore, the content of Mo is preferably 1.3 to 2.8%, more preferably 1.8 to 2.8%, and even more preferably set to 2.25 to 2.35%.

Nb is an element that, in the nitrogen absorption treatment, enhances the transfer rate of nitrogen to the ferrite phase and the diffusion rate of nitrogen in the ferrite phase. When Nb is less than 0.05%, the transfer rate and the diffusion rate of nitrogen become low. On the other hand, when Nb exceeds 0.05%, the material hardens and the processability thereof is negatively affected. Furthermore, a deposition portion is produced, diminishing the aesthetic appearance. Therefore, the content of Nb is preferably 0.05 to 0.50%, more preferably 0.05 to 0.35%, and even more preferably 0.15 to 0.25%.

Cu is an element that, in the nitrogen absorption treatment, controls the absorption of nitrogen in the ferrite phase. When Cu is less than 0.1%, a variation in nitrogen content in the ferrite phase increases. On the other hand, when Cu exceeds 0.8%, the transfer rate of nitrogen to the ferrite phase becomes low. Therefore, the content of Cu is preferably 0.1 to 0.8%, more preferably 0.1 to 0.2%, and even more preferably 0.1 to 0.15%.

Ni is an element that, in the nitrogen absorption treatment, inhibits the transfer of nitrogen to the ferrite phase and the diffusion of nitrogen in the ferrite phase. When Ni is greater than or equal to 0.05%, the transfer rate and the diffusion rate of nitrogen decrease. Furthermore, the corrosion resistance may be negatively affected, and prevention of the occurrence of metal allergies and the like may become difficult. Therefore, the content of Ni is preferably less than 0.5%, more preferably less than 0.2%, and even more preferably less than 0.1%.

Mn is an element that, in the nitrogen absorption treatment, inhibits the transfer of nitrogen to the ferrite phase and the diffusion of nitrogen in the ferrite phase. When Mn is greater than or equal to 0.8%, the transfer rate and the diffusion rate of nitrogen decrease. Therefore, the content of Mn is preferably less than 0.8%, more preferably less than 0.5%, and even more preferably less than 0.1%.

Si is an element that, in the nitrogen absorption treatment, inhibits the transfer of nitrogen to the ferrite phase and the diffusion of nitrogen in the ferrite phase. When Si is greater than or equal to 0.05%, the transfer rate and the diffusion rate of nitrogen decrease. Therefore, the content of Si is preferably less than 0.5%, and more preferably less than 0.3%.

P is an element that, in the nitrogen absorption treatment, inhibits the transfer of nitrogen to the ferrite phase and the diffusion of nitrogen in the ferrite phase. When P is greater than or equal to 0.10%, the transfer rate and the diffusion rate of nitrogen decrease. Therefore, the content of P is preferably less than 0.10%, and more preferably less than 0.03%.

S is an element that, in the nitrogen absorption treatment, inhibits the transfer of nitrogen to the ferrite phase and the diffusion of nitrogen in the ferrite phase. When S is greater than or equal to 0.05%, the transfer rate and the diffusion rate of nitrogen decrease. Therefore, the content of S is preferably less than 0.05%, and more preferably less than 0.01%.

N is an element that, in the nitrogen absorption treatment, inhibits the transfer of nitrogen to the ferrite phase and the diffusion of nitrogen in the ferrite phase. When N is greater than or equal to 0.05%, the transfer rate and the diffusion rate of nitrogen decrease. Therefore, the content of N is preferably less than 0.05%, and more preferably less than 0.01%.

C is an element that, in the nitrogen absorption treatment, inhibits the transfer of nitrogen to the ferrite phase and the diffusion of nitrogen in the ferrite phase. When C is greater than or equal to 0.05%, the transfer rate and the diffusion rate of nitrogen decrease. Therefore, the content of C is preferably less than 0.05%, and more preferably less than 0.02%.

Surface Layer

The surface layer 222 is formed by subjecting a base material constituting the base portion 221 to a nitrogen absorption treatment, thereby austenitizing the ferrite phase. A thickness a of the surface layer 222 is a thickness of the layer formed of the austenitic phase, and is the shortest distance from a front surface 222A of the surface layer 222 to the ferrite phase of the mixed layer 223 in a visual field when observed with a scanning electron microscope (SEM) at a magnification of 500 to 1000, for example. Alternatively, the thickness a is from the front surface 222A of the surface layer to the shallowest austenitic phase. Further, the distances of a plurality of points having a short distance from the surface 222A of the surface layer 222 to the ferrite phase may be measured, and the average value thereof may be set as the thickness a of the surface layer 222. Note that the surface layer 222 is formed on the exposed surface side of the case back 22 when the case back 22 is attached to the case main body 21. In this exemplary embodiment, the content of nitrogen in the surface layer 222 is, in mass %, 1.0 to 1.6%.

Further, in this exemplary embodiment, a nitrogen absorption treatment is performed so that a distance a from the front surface 222A to the mixed layer 223 is 350 μm in a cross-sectional view in which the case back 22 is cut in a direction orthogonal to the front surface 222A. That is, the surface layer 222 is formed so that the thickness at the shallowest location is 350 μm. As a result, the hardness and the corrosion resistance required in the case back 22 can be ensured. Note that the surface layer 222 is not limited to the configuration described above. For example, the surface layer 222 may be configured so that the distance a is greater than or equal to 350 μm or so that the distance a is less than or equal to 350 μm, and may be formed in accordance with the required hardness and corrosion resistance.

Furthermore, in this exemplary embodiment, the front surface 222A of the surface layer 222 is mirror-finished. As a result, the front surface 222A is a mirror surface. Specifically, the front surface 222A is configured so that an arithmetical mean roughness Ra is approximately 19 nm.

Mixed Layer

In the process of forming the surface layer 222, the mixed layer 223 is produced due to variations in the transfer rate of nitrogen that enters the base portion 221 formed of the ferrite phase. That is, nitrogen enters and is austenitized to a deep location of the ferrite phase at a location where the transfer rate of nitrogen is fast, and is austenitized only to a shallow location of the ferrite phase at a location where the transfer rate of nitrogen is slow, and thus the mixed layer 223 in which the ferrite phase and the austenitic phase are mixed in the depth direction is formed. Note that the mixed layer 223 is a layer including the shallowest area to the deepest area of the austenitic phase in a cross-sectional view, and is a layer thinner than the surface layer 222.

Recessed Portion

The recessed portion 224 is formed in the surface layer 222, and is formed into a rectangular shape including side surfaces 225 and a bottom surface 226 continuous from the side surfaces 225 in the cross-sectional view described above. Note that the recessed portion 224 is not limited to being formed into a rectangular shape in the cross-sectional view, and may be formed into, for example, a substantially triangular shape, a substantially trapezoidal shape, or a substantially semicircular shape in the cross-sectional view. Further, in this exemplary embodiment, the recessed portion 224 constitutes the model number 23, the water resistance performance indication 24, and the magnetic resistance performance indication 25 illustrated in FIG. 2.

The recessed portion 224 is formed so that a distance b from the front surface 222A to the bottom surface 226, that is, the distance b corresponding to the shortest distance from the deepest location of the recessed portion 224 to the front surface 222A, is shorter than the distance a from the front surface 222A to the mixed layer 223. Specifically, the recessed portion 224 is formed so that the distance b is less than 350 μm. As a result, the recessed portion 224 does not penetrate the surface layer 222 and reach the mixed layer 223, and thus the ferrite phase is not exposed through the recessed portion 224. Further, the recessed portion 224 is preferably formed so that the distance b described above is less than or equal to 100 μm, and more preferably less than or equal to 20 μm. With the recessed portion 224 thus configured, when the recessed portion 224 is formed by laser machining as described later, a machining time of the laser machining can be shortened, and a productivity of the case back 22 can be improved.

Furthermore, the recessed portion 224 is formed so that the distance b described above is greater than or equal to 1.5 μm. As a result, a contrast between the bottom surface 226 and the front surface 222A required to distinguish the recessed portion 224 and the front surface 222A can be ensured. Therefore, a visibility of the model number 23, the water resistance performance indication 24, and the magnetic resistance performance indication 25 constituted by the recessed portion 224 can be ensured. Further, the recessed portion 224 is preferably formed so that the distance b described above is greater than or equal to 3 μm, and more preferably greater than or equal to 5 μm. With the recessed portion 224 thus configured, the contrast between the bottom surface 226 and the front surface 222A can be further increased, and thus the visibility of the model number 23, the water resistance performance indication 24, and the magnetic resistance performance indication 25 can be improved.

That is, in this exemplary embodiment, the recessed portion 224 is formed so that the distance b is greater than or equal to 1.5 μm and less than 350 μm, thereby making it possible to prevent exposure of the ferrite phase and ensure the visibility of the model number 23, the water resistance performance indication 24, and the magnetic resistance performance indication 25.

Further, the recessed portion 224 is preferably formed so that the distance b is greater than or equal to 3 μm and less than or equal to 100 μm, and more preferably greater than or equal to 5 μm and less than or equal to 20 μm. With the recessed portion 224 thus configured, the productivity of the case back can be improved, and the visibility of the model number 23, the water resistance performance indication 24, and the magnetic resistance performance indication 25 can be improved.

Further, in this exemplary embodiment, as described above, the recessed portion 224 that constitutes the model number 23, the water resistance performance indication 24, and the magnetic resistance performance indication 25 is formed by a portion of the surface layer 222 being vaporized and marked by laser machining. With the recessed portion 224 thus formed by laser machining, the bottom surface 226 is a rough surface. Specifically, the bottom surface 226 is formed so that the arithmetical mean roughness Ra is approximately 500 nm. That is, the bottom surface 226 is formed so that the arithmetical mean roughness Ra is different from that of the front surface 222A of the surface layer 222, and specifically, the bottom surface 226 is formed so that the arithmetical mean roughness Ra is greater than that of the front surface 222A. As a result, the contrast between the front surface 222A and the bottom surface 226 can be increased, and thus the visibility of the model number 23, the water resistance performance indication 24, and the magnetic resistance performance indication 25 constituted by the recessed portion 224 can be improved. Note that the bottom surface 226 is preferably formed so that the arithmetical mean roughness Ra differs from that of the front surface 222A by, for example, five times or more, and more preferably 10 times or more.

Furthermore, in this exemplary embodiment, the bottom surface 226 and the front surface 222A differ in reflectance. Specifically, the bottom surface 226 is formed so that the reflectance is less than that of the front surface 222A. As a result, the contrast between the front surface 222A and the bottom surface 226 can be further increased, and thus the visibility of the model number 23, the water resistance performance indication 24, and the magnetic resistance performance indication 25 constituted by the recessed portion 224 can be improved.

Action and Effect of the Exemplary Embodiment

According to this exemplary embodiment, the following advantageous effects can be produced.

In this exemplary embodiment, the case back 22, which is the timepiece component, is formed of the austenitic-ferritic stainless steel including the base portion 221 formed of the ferrite phase, the surface layer 222 formed of the austenitic phase, and the mixed layer 223 in which the ferrite phase and the austenitic phase are mixed. The recessed portion 224 is formed in the surface layer 222. Then, the recessed portion 224 is formed so that the distance b from the front surface 222A to the bottom surface 226 is shorter than the distance a from the front surface 222A to the mixed layer 223.

As a result, the recessed portion 224 does not penetrate the surface layer 222 and reach the mixed layer 223, making it possible to prevent exposure of the ferrite phase through the recessed portion 224. Therefore, it is possible to obtain the case back 22 as a timepiece component that can ensure corrosion resistance and to which a marking for an identification description or a representation of the design is applied.

In this exemplary embodiment, the recessed portion 224 is formed so that the distance b from the front surface 222A to the bottom surface 226 is greater than or equal to 1.5 μm and less than 350 μm.

As a result, exposure of the ferrite phase can be prevented and the visibility of the model number 23, the water resistance performance indication 24, and the magnetic resistance performance indication 25 constituted by the recessed portion 224 can be ensured.

In this exemplary embodiment, the recessed portion 224 is formed so that the arithmetical mean roughness Ra of the bottom surface 226 is different from the arithmetical mean roughness Ra of the front surface 222A.

As a result, the contrast between the front surface 222A and the bottom surface 226 can be increased, and thus the visibility of the model number 23, the water resistance performance indication 24, and the magnetic resistance performance indication 25 constituted by the recessed portion 224 can be improved.

In this exemplary embodiment, the recessed portion 224 is formed by laser machining.

As a result, the distance b from the front surface 222A to the bottom surface 226 of the recessed portion 224 can be easily adjusted by adjusting irradiation conditions of the laser beam, and thus the recessed portion 224 can be easily formed.

Next, a specific example will be described.

### Example

A method for forming, on the case back serving as the timepiece component of an example, the recessed portion constituting the model number, the water resistance performance indication, and the magnetic resistance performance indication by laser machining will now be described.

First, a metal material in which an austenitized surface layer is formed was obtained by manufacturing a base material made of a ferritic stainless steel containing, in mass %, 20% of Cr, 2.1% of Mo, 0.2% of Nb, 0.1% of Cu, 0.05% of Ni, 0.5% of Mn, 0.3% of Si, 0.03% of P, 0.01% of S, 0.01% of N, and 0.02% of C, with the balance being Fe and unavoidable impurities, and subjecting the base material to a nitrogen absorption treatment. Then, the metal material was machined to manufacture a case back.

Next, laser machining was performed on the front surface of the case back manufactured as described above, that is, on the surface of the exposed side when the case back is attached to the case main body, to form recessed portions that constitute the model number, the water resistance performance indication, and the magnetic resistance performance indication.

Specifically, a laser machining device was used under laser irradiation conditions of a wavelength of 532 nm, an average power of 4 W, a switch frequency of 100 kHz, and a scanning speed of 1000 mm/s to form the recessed portions.

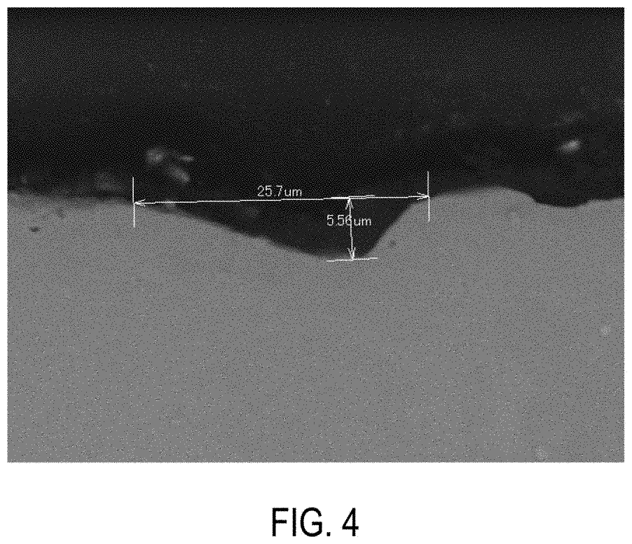

FIG. 4 is a photograph, captured by an SEM, of a cross section of the case back laser-machined as described above.

As shown in FIG. 4, it is suggested that, by performing the laser machining under laser irradiation conditions such as described above, a recessed portion having a distance from the front surface to the bottom surface of 5.56 μm can be formed. That is, it is suggested that a recessed portion having a distance from the front surface to the bottom surface of greater than or equal to 1.5 μm and less than 350 μm can be formed. Accordingly, it is suggested that, by performing laser machining under conditions such as described above, it is possible to form, on the case back, the water resistance performance indication and the magnetic resistance performance indication that can prevent exposure of the ferrite phase and ensure visibility.

### Modification Example

Note that the present disclosure is not limited to each of the exemplary embodiments described above, and variations, modifications, and the like within the scope in which the object of the present disclosure can be achieved are included in the present disclosure.

In the exemplary embodiments described above, the timepiece component of the present disclosure was configured as the case back 22, but is not limited thereto. For example, the timepiece component of the present disclosure may be configured as a case body, a bezel, a strap, a clasp, a dial, or the like. Further, the timepiece may also include a plurality of timepiece components such as described above.

In the exemplary embodiments described above, the model number 23, the water resistance performance indication 24, and the magnetic resistance performance indication 25 serving as the letter and the number of the present disclosure were constituted by the recessed portion 224, but the present disclosure is not limited thereto. For example, an engraving, a mark, a code, an emblem, a symbol, or the like may be constituted by the recessed portion, and at least one of a letter, a number, a sign, an engraving, a mark, a code, an emblem, and a symbol may be constituted by the recessed portion.

In the exemplary embodiments described above, the front surface 222A of the surface layer 222 is mirror-finished, but is not limited thereto. For example, the front surface 222A may be hairline-finished and include a rough surface having an arithmetical mean roughness Ra of approximately 120 nm. In this case, the bottom surface 226 may be a rough surface having an arithmetical mean roughness Ra of approximately 800 nm to increase the contrast with the front surface 222A.

Furthermore, the bottom surface 226 may be formed so that the arithmetical mean roughness Ra is less than that of the front surface 222A.

In the exemplary embodiments described above, the recessed portion 224 is formed by laser machining, but is not limited thereto. For example, the recessed portion 224 may be formed by electron beam irradiation or mechanical processing such as cutting.

In the exemplary embodiments described above, the surface layer 222 is formed on the exposed surface side of the case back 22 when the case back 22 is attached to the case body 21, but is not limited thereto. For example, the surface layer may be formed across the entire front surface of the timepiece component, such as the case back.

In the exemplary embodiments described above, the bottom surface 226 is formed so that the reflectance is less than that of the front surface 222A, but is not limited thereto. For example, the bottom surface 226 may be formed so that the reflectance is greater than that of the front surface 222A.

In the exemplary embodiments described above, the metal material of the present disclosure that uses a ferritic stainless steel as a base material constitutes the case back serving as the timepiece component, but is not limited thereto. For example, the metal material of the present disclosure may constitute a case of an electronic apparatus other than a timepiece, that is, an electronic apparatus component such as a housing. With the housing formed of such a metal material, the electronic apparatus can ensure corrosion resistance after a marking for an identification description or a representation of the design is applied thereto.

What is claimed is:

1. A timepiece component formed of an austenitic-ferritic stainless steel including a base portion formed of a ferrite phase, a surface layer formed of an austenitic phase, and a mixed layer formed between the base portion and the surface layer and obtained by mixing the ferrite phase and the austenitic phase, wherein
a recessed portion is formed in the surface layer and
a distance from a front surface of the surface layer to a bottom surface of the recessed portion is shorter than a distance from the front surface to the mixed layer.

2. The timepiece component according to claim 1, wherein
the distance from the front surface to the bottom surface is greater than or equal to 1.5 μm and less than 350 μm.

3. The timepiece component according to claim 1, wherein
the distance from the front surface to the bottom surface is from 5 μm to 20 μm.

4. The timepiece component according to claim 1, wherein
an arithmetical mean roughness Ra of the bottom surface is different from an arithmetical mean roughness Ra of the front surface.

5. The timepiece component according to claim 2, wherein
an arithmetical mean roughness Ra of the bottom surface is different from an arithmetical mean roughness Ra of the front surface.

6. The timepiece component according to claim 3, wherein
an arithmetical mean roughness Ra of the bottom surface is different from an arithmetical mean roughness Ra of the front surface.

7. The timepiece component according to claim 1, wherein
the recessed portion constitutes at least one of a letter, a number, a sign, an engraving, a mark, a code, an emblem, and a symbol.

8. The timepiece component according to claim 2, wherein
the recessed portion constitutes at least one of a letter, a number, a sign, an engraving, a mark, a code, an emblem, and a symbol.

9. The timepiece component according to claim 3, wherein
the recessed portion constitutes at least one of a letter, a number, a sign, an engraving, a mark, a code, an emblem, and a symbol.

10. The timepiece component according to claim 4, wherein
the recessed portion constitutes at least one of a letter, a number, a sign, an engraving, a mark, a code, an emblem, and a symbol.

11. The timepiece component according to claim 5, wherein
the recessed portion constitutes at least one of a letter, a number, a sign, an engraving, a mark, a code, an emblem, and a symbol.

12. A timepiece comprising:
the timepiece component according to claim 1.

13. A timepiece comprising:
the timepiece component according to claim 2.

14. A timepiece comprising:
the timepiece component according to claim 3.

15. A timepiece comprising:
the timepiece component according to claim 4.

16. A timepiece comprising:
the timepiece component according to claim 5.

17. A timepiece comprising:
the timepiece component according to claim 6.
